(19) United States
(12) Patent Application Publication
(10) Pub. No.: US 2017/0169181 A1
(43) Pub. Date: Jun. 15, 2017

(54) Patient-Case Sorting Method for Medical Procedures

(71) Applicants: Michael Shumer, Jacksonville Beach, FL (US); Bernard Frazer, Jacksonville Beach, FL (US); Nicholas Dodaro, Atlantic Beach, FL (US)

(72) Inventors: Michael Shumer, Jacksonville Beach, FL (US); Bernard Frazer, Jacksonville Beach, FL (US); Nicholas Dodaro, Atlantic Beach, FL (US)

(21) Appl. No.: 14/965,361

(22) Filed: Dec. 10, 2015

(51) Int. Cl. G06F 19/00; G06F 17/30

(52) U.S. Cl. CPC G06F 19/3443; G06F 17/3053; G06F 17/30345; G06F 17/30424

(57) ABSTRACT

The present invention provides a method to stratify patient-cases based on acuity for patient care performed outside of the hospital setting. Using medical code combinations, diagnostic code information, and patient demographic data, the method sorts and ranks patient cases to determine the level of acuity and predicts whether a hospital admission or hospital observation is prevented. The invention presents a program that uses patient-case information recorded by care-givers and accumulated over the course of an observation period. The method analyzes patient-case data and categorizes the observed patient-cases. Once categorized, the extent of successful emergency room diversion can be assessed. In addition to showing the number of patient-cases diverted from the emergency room, using market data comparisons, cost savings reports can be generated quantifying the total estimated savings over a reporting period based on prevented hospital admissions and observations. Other benefits relating to the method are disclosed herein.

### CROSS-REFERENCES TO RELATED APPLICATIONS

This application claims priority under 35 U.S.C. §119(e) to U.S. Provisional Application Ser. No. 62/090,329 filed Dec. 10, 2014, by Michael Shumer, Nicholas Dodaro, and Bernard Frazer, which is incorporated herein by reference in its entirety.

### STATEMENT REGARDING FEDERALLY SPONSORED RESEARCH OR DEVELOPMENT

Not Applicable.

### MICROFICHE APPENDIX

Not Applicable

### BACKGROUND

In the last decade, the federal government, many state governments, and medical care practitioners in the marketplace have identified that emergency room (“ER”) diversion (appropriately keeping patients out of a hospital ER, and therefore avoiding a possible admission into the hospital) can create significant savings and have many other benefits to the healthcare system. Accordingly new methods to quantify ER diversion success are needed.

### DESCRIPTION

The goal of an ER diversion strategy is to prevent unnecessary ER visits, and consequently reduce the number of unnecessary hospital admissions since greater than one-half of all hospital admissions come from patients that were treated in the ER. A successful ER diversion strategy reduces overcrowding in our nation's hospitals, results in cost savings for the patients and the medical system, and can increase the quality of care. The method disclosed provides a structured and proven means to illustrate the success of ER diversion associated with a certain level of outpatient care. Success is measured based on quantifying the number of patients diverted from the ER. In addition to reducing the unnecessary strain on the ER and the related hospitals, cost savings can also be realized and quantified. At many levels, the method gives a firm basis to support ER diversion and illustrates the efficiency of outpatient care.

In today's medical environment, there are three general venues of care where patients can receive unscheduled medical care: These include (1) the ER and related hospitals; (2) primary care physicians, urgent care or other retail clinics; and (3) the recently developed acute urgent care centers. Each of these facilities has varying capabilities and capacities which are further described below.

The ER-hospital combination consists of highly capable facilities that provide many levels of unscheduled care, but they may not be cost effective or efficient, especially when used to perform more rudimentary procedures. ERs can also generate a majority (up to seventy percent [70%]) of a hospital's admitted patients (admissions); however it must be recognized that some patients are summarily discharged when the condition for which treatment is sought lacks the appropriate level of acuity. For these less complicated procedures, some alternative venues for unscheduled care are more appropriate and far less expensive.

The alternatives for less severe patient-cases include primary care offices, urgent care centers, and other retail clinics. Although the capabilities associated with these venues are limited (capable of handling only the bottom thirty percent [30%] of the cases that an ER can handle), they often capably manage the less severe (low acuity) cases presented. Overall, the low acuity cases managed in these alternative venues are unlikely to ever be candidates to be admitted into a hospital. Further, patients selecting this mode of care are not as likely to consider the ER as care option. In general, these alternative venues of care that can only handle low acuity cases are not meaningful contributors to an ER Diversion strategy for these reasons.

Finally, the third type of healthcare facilities handle both low and high acuity unscheduled cases and meet a similar standard of care met in the ER and hospital. These venues are typically referred to as “acute urgent care” centers, although other descriptions include “advanced urgent care” and “higher acuity urgent care” centers. These venues can provide appropriate care for moderate and high acuity cases, so they can consequently help a patient avoid the need to be admitted to the hospital, and thereby creating a Saved Admission. Saved Admissions are cases that were appropriately and successfully treated in an acute urgent care center or other non-ER outpatient venues and consequently the case was not admitted into a hospital. Similarly, acute urgent care centers can provide a level of care that matches the testing and observation that are performed in the ER-hospital setting. Because the acute urgent care centers have similar capabilities to ERs, patient-cases addressed in these facilities are appropriate Save Admission or Saved Observation candidates. Acute urgent care centers have become of great interest to be used to divert patient-cases from the ER and potentially the related hospital.

It has become commonplace for patients to be without a primary care physician. As such, a typical pathway to a hospital admission has become as follows. Patients in need of unscheduled care arrive in the ER and can be subsequently admitted into the hospital for treatment, procedures and tests. ERs and the related hospitals, as care delivery models, have the capabilities to handle the full spectrum of unscheduled care (no appointments); however, only the patients with moderate and serious cases that are admitted into the hospital (minor cases are usually discharged and not admitted into the hospital). Based on the inventor's and other analyses, care provided in a hospital (“inpatient care”) is expensive relative to care provided outside of a hospital (“outpatient care”) and represents an inefficient use of resources. One 2007 study conducted by the National Association of Community Health Centers, Inc., supports this finding and indicates that over $18 billion dollars are wasted annually on avoidable inpatient care.

Nationally, medical procedures performed at hospitals account for up to forty percent (40%) of the total healthcare performed on a cost basis. This large percentage contributes to a greater economic problem described because as a general proposition, hospitals are very expensive venues in which to receive care. Americans are spending more money on healthcare as a percentage of GDP than any other country in the world. Currently, the majority of the hospital general care admissions (patients admitted into the hospital to receive care) come from patients that arrive in the ER first and not from referring doctors who are scheduling procedures based on the needed hospital level resources.

In addition to acute urgent care centers, many non-hospital facilities can provide care or testing that matches the level of service provided in a hospital. One example, where comparable care is often provided by outpatient clinics, is in the field of magnetic resonance imaging procedures. Further, when care is provided on an outpatient basis, it is typically much less expensive than when the same procedure is provided in a hospital. In 2006, the Institute of Medicine reported that inpatient care charges for non urgent problems may be between two and five times higher than charges for the same procedures in a typical private physician office. Unfortunately, despite the potential savings patients and insurance companies can experience through outpatient care, since hospitals have a significant financial overhead burden associated with large capital expenses, there can be a tendency to operate in a mode of convenience and direct patients toward inpatient care (e.g. Resulting in an unnecessary hospital admission) as opposed to appropriately coordinating necessary care in an outpatient environment. The method presented here can help cure this care coordination failure.

Prior to the recent deployment of acute urgent care centers to divert patients from the ER for either treatment or other testing, there was little need to identify a “Saved Admission,” a “Saved Observation” (also called “Saved Obs,” which is a less intensive hospital admission, usually lasting less than 24 hours), or to clearly identify whether an unscheduled outpatient case is low or high acuity (since previously, only an ERwas thought to be able to appropriately handle high acuity unscheduled cases). Using medical code combinations, diagnostic code information, and patient data, the method presented here determines whether a patient treated in an acute urgent care center would have qualified for admission to a hospital. The patient-cases that are serious enough for hospital treatment are also stratified based on acuity. Based on the stratified data, cost savings that result when an acute urgent care center (or other outpatient care delivery models that rival the capabilities of the typical ER) effectively diverts patients from the ER can be calculated. In addition, care coordination can be evaluated, and if the method is performed in parallel at an ER/hospital combination, the progress of ER diversion efforts can be charted as related increases and decreases of certain patient-cases should be noted.

The healthcare marketplace has been challenged to agree on a methodology that can clearly delineate between a low and high acuity case. Truly, it is only in areas where capability overlap exists that a Saved Admission or Saved Obs can arise. To quantify the success an alternate venue has in diverting patients from an ER, some preliminary screening must be done for the cases under consideration. This exemplary implementations of the broad inventive principles described herein provide a method to distinguish between and segregate the cases during its Acuity Analysis. This analysis is based on governing rules being applied to patient diagnoses or CPT codes in combination with the International Statistical Classification of Disease (“ICD”) codes and/or other patient data. Following the Acuity Analysis, high acuity cases are further analyzed to determine if the patient diagnoses and criteria qualifies as a Saved Admission or some other category which can demonstrate cost savings or other benefits.

Exemplary implementations of the broad inventive principles described herein provide a method to stratify patient-cases based on acuity for patient care performed outside of the hospital setting. Using medical code combinations, diagnostic code information, and patient demographic data, the method sorts and ranks patient cases to determine the level of acuity and projects whether a hospital admission or hospital observation is prevented. Exemplary implementations present a program that uses patient-case information recorded by care-givers and accumulated over the course of an observation period. The method analyzes patient-case data and categorizes the observed patient-cases. Once categorized, the extent of successful emergency room diversion can be assessed. In addition to showing the number of patient-cases diverted from the emergency room, using market data comparisons, cost savings reports can be generated quantifying the total estimated savings over a reporting period based on prevented hospital admissions and observations. Other benefits relating to the method are disclosed herein.

Exemplary implementations provide a patient screening method that evaluates patient visits to an acute urgent care facility or other type of medical facility that has capabilities comparable to an ER/hospital setting. The method can also be applied to patient-cases occurring in an ER/hospital setting to evaluate the success rate of ER diversion programs. In an exemplary embodiment, over a given time interval, patient data is input in a database and maintained at an acute urgent care facility. Data that is recorded includes the patient identifier (case number), age, whether they are a new patient or not, respective diagnosis code, and all applicable current procedural terminology (“CPT”) codes ascribed to the patient. Any number of patients can be included and considered in the method, but ultimately the number of patients considered will be those patients seen during the analysis period. For instance, should the user desire a monthly evaluation of cases, only patient data for visits to the acute urgent care facility during the analysis month would be considered in the method. However, because ER diversion programs can take many months to years to effect change, it is important that the method include an electronic database to track the hundreds and perhaps thousands of patient-case files for analysis.

Certain CPT codes are recognized by medical practitioners for acute and high-acuity cases. During its acuity analysis, by evaluating patients by CPT codes, the method cross references CPT codes or CPT code combinations (so called “trigger” codes that can identify a case as a being a “trigger case”) that are known in the medical community to be associated with patient cases that typically result in a hospital admissions. If a patient's CPT code is not identified or matched with the list of “trigger cases” in the method database, the patient is considered to be a low acuity case and they are not considered for further cost savings analysis. The remaining cases, not screened out, are high acuity cases. These cases are those where had those patients gone to an ER first, they would have typically been admitted, treated and/or observed before discharge from the hospital. These cases are further evaluated in the method to determine how each case is managed in an outpatient setting or it is noted if a given patient, due to the complexity of his case, is ultimately referred to and admitted to a hospital for scheduled procedures or care. The level of care required for these patient cases—those that are saved from hospital admission—dictates the level of savings that can be realized through the use of outpatient care. In addition to cost savings, other benefits are realized through the outpatient-inpatient combination as the patient's eventual hospital visit will be more streamlined and result in less strain on hospital resources.

Within the trigger cases identified through the acuity analysis, cases classified as Saved Admissions are determined. These are patient-cases whose diagnoses are combined with set first and second tier defining parameters to determine whether they would have been admitted into the hospital but for the care administered at the acute urgent care facility. If the combination of factors would have typically led to hospital admissions, but the patients were effectively treated exclusively on an outpatient basis, those patients would qualify as Saved Admissions. If patients are ultimately referred to the hospital following initial outpatient care, those patients are classified as Admissions to Hospital in the method. Once Saved Admissions and Admissions to Hospital cases are identified, they are removed from the patient data set under analysis so that the remaining data can be further evaluated without interference.

Certain trigger cases would not normally be admitted to the hospital, but they can be retained at the hospital for testing and observation due to the acuity of the condition. This observation typically occurs over less than a twenty-four (24) hour period. Many times, these cases can be effectively managed through outpatient care and inpatient observation can be avoided. An avoided observation case is termed a Saved Obs in this method. As with the determination of Saved Admissions, Saved Obs are those cases that meet one of three criteria related to industry Evaluation and Management codes. Once the Saved Obs are identified, they are removed from the patient data set so that the data can be further evaluated.

Finally, certain trigger cases are neither admitted nor retained at the hospital for any extended length of time. These cases would be treated and sent home. In this method, these cases are described as High Acuity Treated & Discharged. Although these cases require the least level of inpatient medical attention, treating these cases in an outpatient setting can still yield cost savings and benefits. Due to the top down analysis and screening of the method wherein cases are removed from the data set based on acuity, these cases are those cases remaining in the data set at the conclusion of the patient sorting steps.

At the completion of the segregation of the trigger cases, one application of the stratified patient-cases is quantifying medical cost savings. Cost savings are based on known cost differentials between the outpatient and inpatient care for the respective levels of medical care and number of cases serviced. These cost differentials are tied to a current market analysis which is updated on an annual basis or as changes occur in the field. Cost savings are typically provided in a report that can be used to illustrate the value added through cost savings by the outpatient medical services over the study period.

In summary, the embodiments of the inventive principles disclosed offer numerous advantages over other methods of ER diversion assessment. One advantage is that the patient-case screening method improves the related art; specifically, patient-cases are stratified based on analyses that evaluate the degree of acuity. A further advantage is that the method categorizes medical cases in a manner that allows for cost savings quantification. A further advantage is that the inventive principles set forth a categorizing method that can assist real time care coordination of patient cases that are more appropriately managed using outpatient rather than inpatient care. An additional advantage is that, through the implementation of the inventive concept, there is a system that can accurately estimate the cost savings associated with the outpatient care furnished by an acute urgent care facility.

### DRAWINGS

FIG. 1 is a flow chart that illustrates an exemplary method and its two stage analysis.

FIG. 2 is a flow chart illustrating the Acuity Analysis.

FIG. 3 is a flow chart illustrating the Saved Admission Review.

FIG. 4 is a flow chart illustrating the Saved Obs Review.

FIG. 5 provides an example of a savings report that can be generated based on the stratification of the patient cases.

Table 1 provides an exemplary listing of CPT Codes that are used to distinguish between high and low acuity cases in the Acuity Analysis.

Tables 1A, 1B, and 1C provide an exemplary listing of the Saved Admission Review algorithm criteria.

Table 2 provides an exemplary listing of the Saved Observations Review algorithm criteria.

### DESCRIPTION OF EXEMPLARY IMPLEMENTATIONS

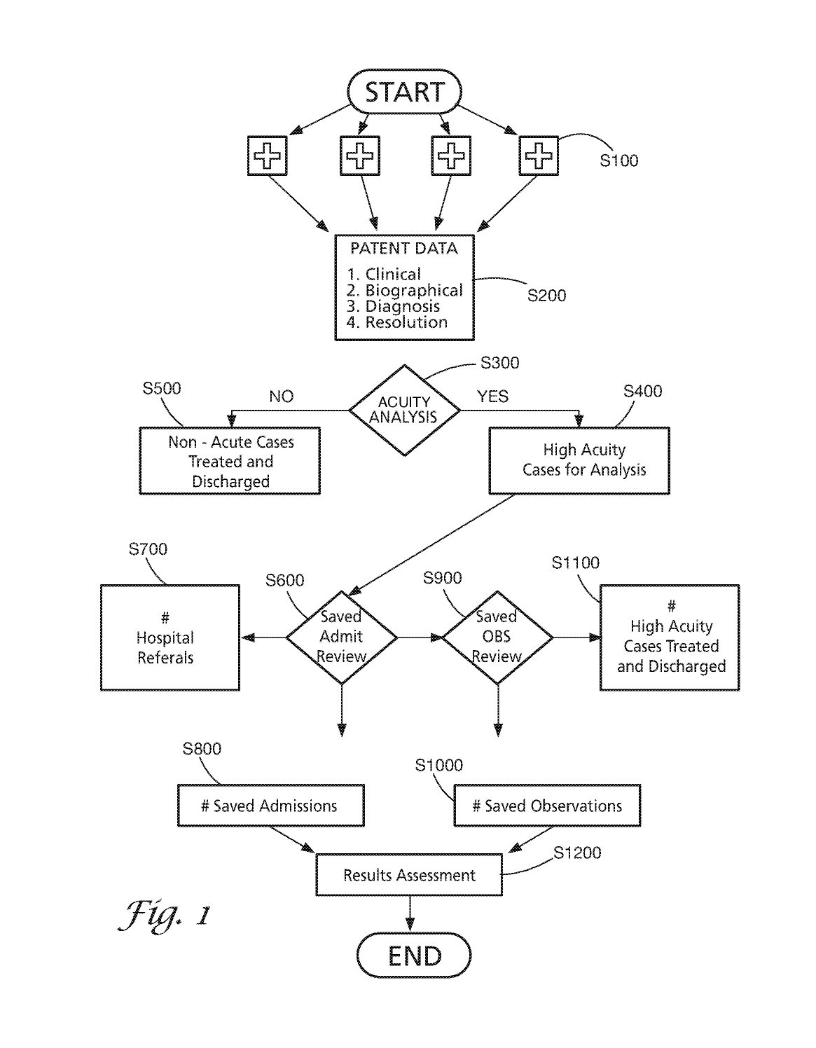

Referring to FIG. 1, in an exemplary implementation of the inventive principles described herein, patient data is charted by care-givers at the time of diagnosis and treatment for a given case (Step S100). As illustrated in Step S100, data can be generated from any number of care givers and care giver locations. All data are uploaded to the patient-case database (Step S200) which includes information such as case number, patient biographic data, patient diagnosis for the visit, clinical information, payment for services rendered, and disposition of the case. The preferred patient-case database is maintained within a program platform that allows data sorting and the performance of algorithms. Once the patient-case database is populated, a healthcare administrator will initiate the Acuity Analysis (Step S300).

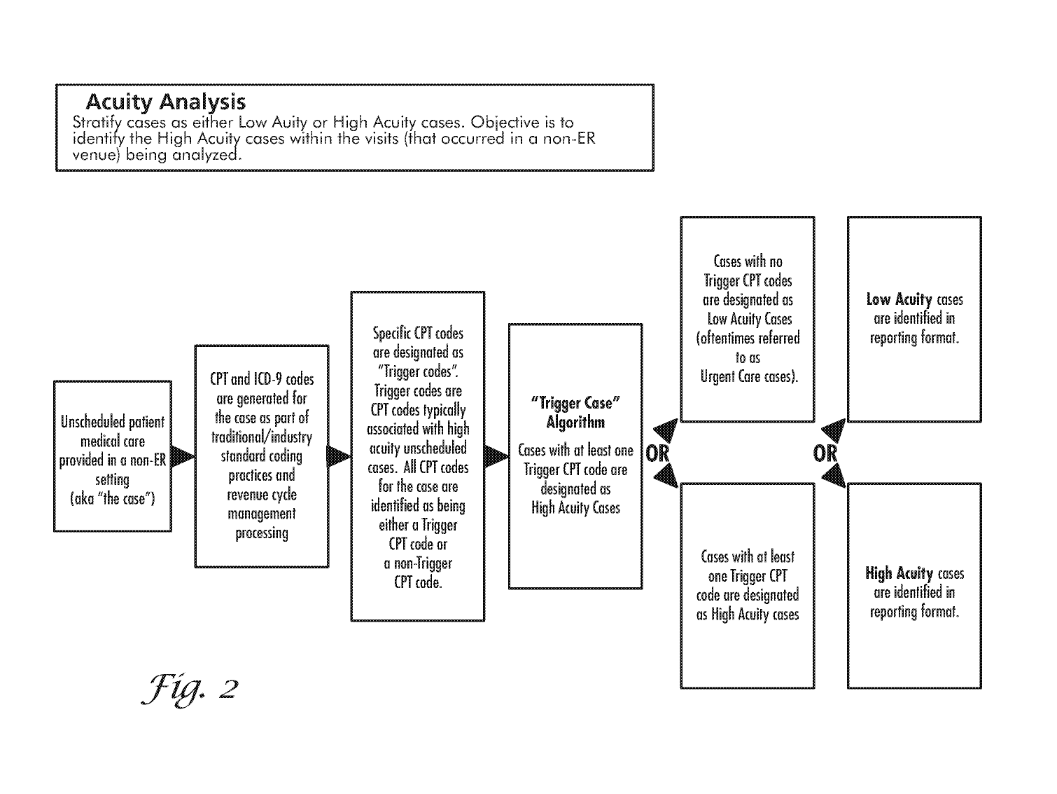

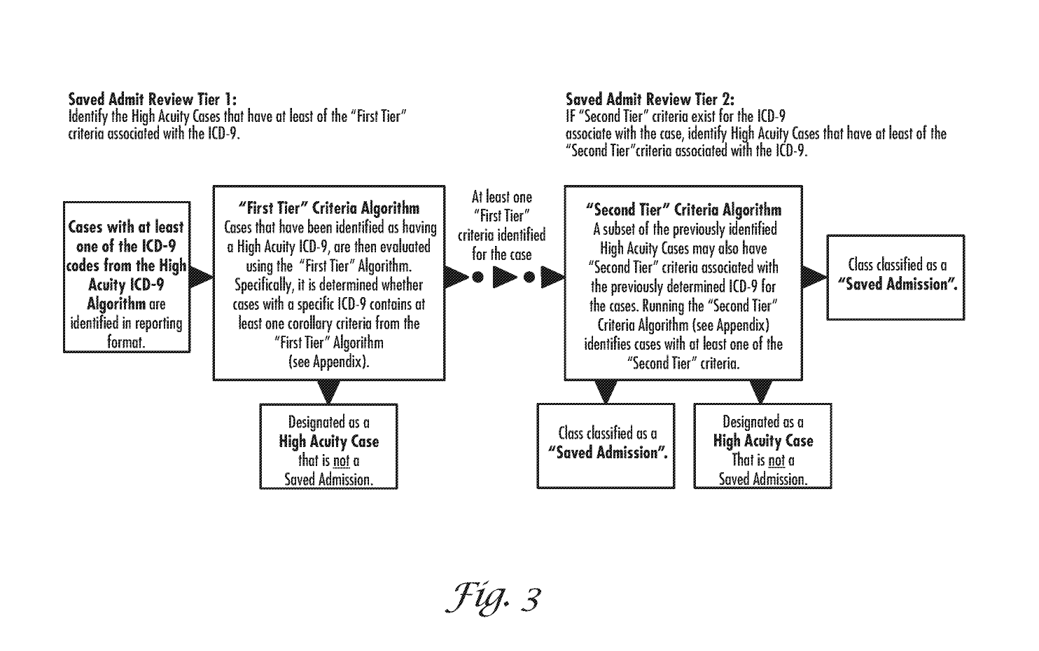

Referring again to FIG. 1, the Acuity Analysis (Step S300) sorts patient-cases based on CPT codes that are listed in Table 1. Patient-cases where the diagnoses include a CPT Code appearing on Table 1 will be noted as High Acuity or Trigger cases (Step S300: YES), and these patient-cases will be placed within a data set for further analysis (Step S400). Patient-cases where the diagnoses do not include CPT Codes listed in Table 1 (Step S300: NO) will be noted as Non-High Acuity cases (S500). These Non-High Acuity patient-cases are identified in reporting format and removed from further evaluation in the method. Referring to FIG. 2, the Acuity Analysis and the Trigger Case algorithm are illustrated in greater detail. Further, definitions are provided for key terms and criteria used in the method algorithms.

Referring again to FIG. 1, the second stage of the method is known as the Saved Admit Review (Step S600). The algorithm for the Saved Admit Review (Step S600) relies on criteria presented in Table 2 and is further described in FIG. 3. Referring to Table 2, in order for a High-Acuity Case to be classified as a Saved Admission (Step S800), the patient-case must include at least one of the diagnoses presented in the Diagnosis Column (Column 1) of Table 2, must include one or more of the first tier parameters (Column 2) of Table 2, and must meet at least one of the second tier parameters (Column 3) if any of these parameters are listed. The diagnoses presented in Column 1 of Table 2 can be substituted with International Classification of Diseases (ICD) Codes for ease of data sorting and referencing.

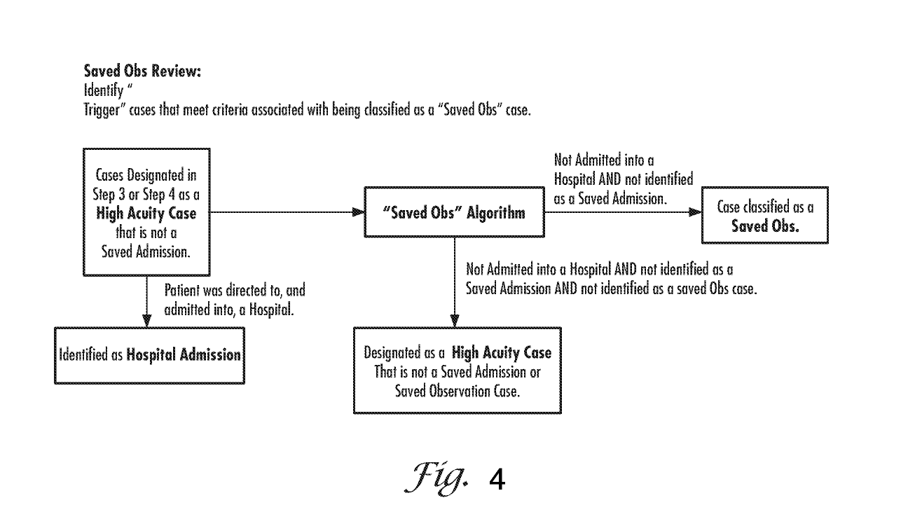

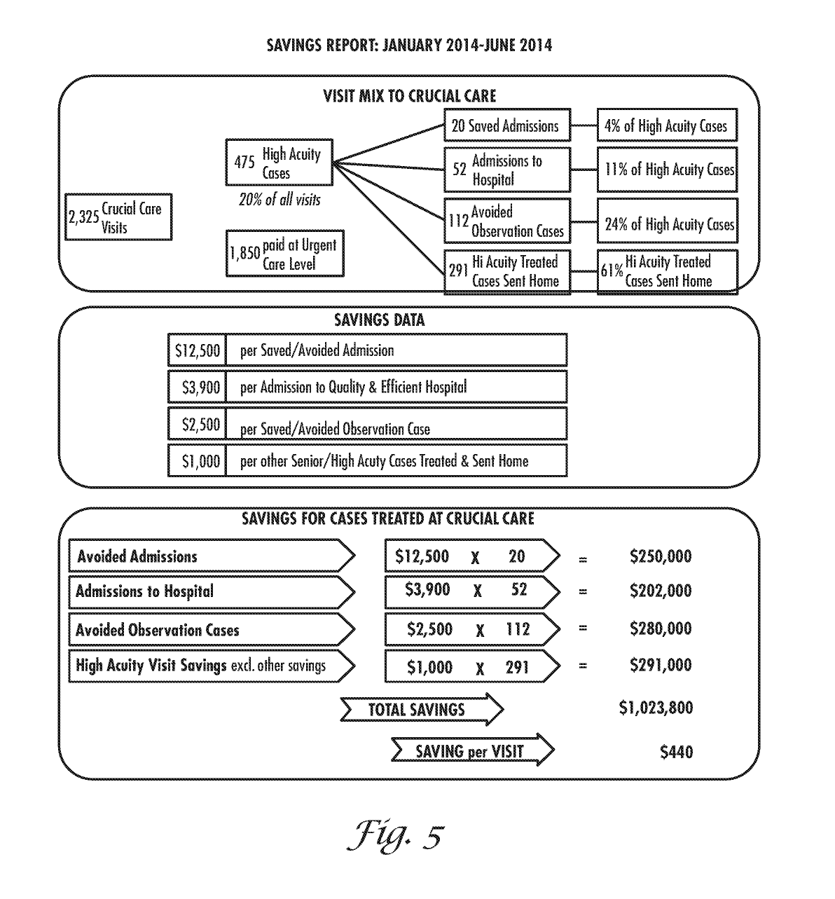

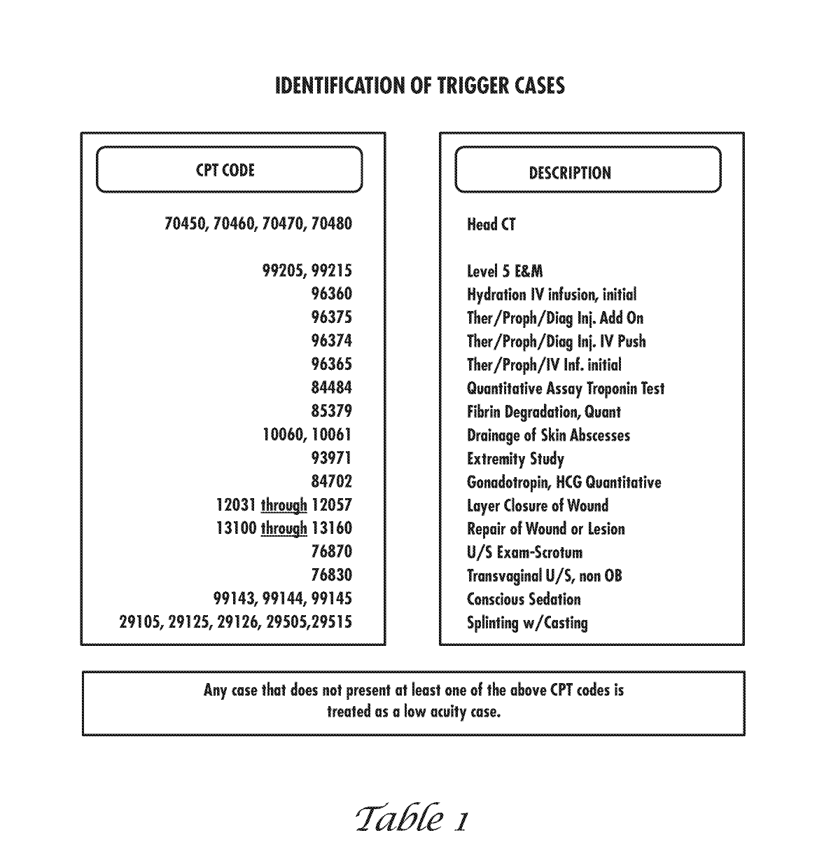

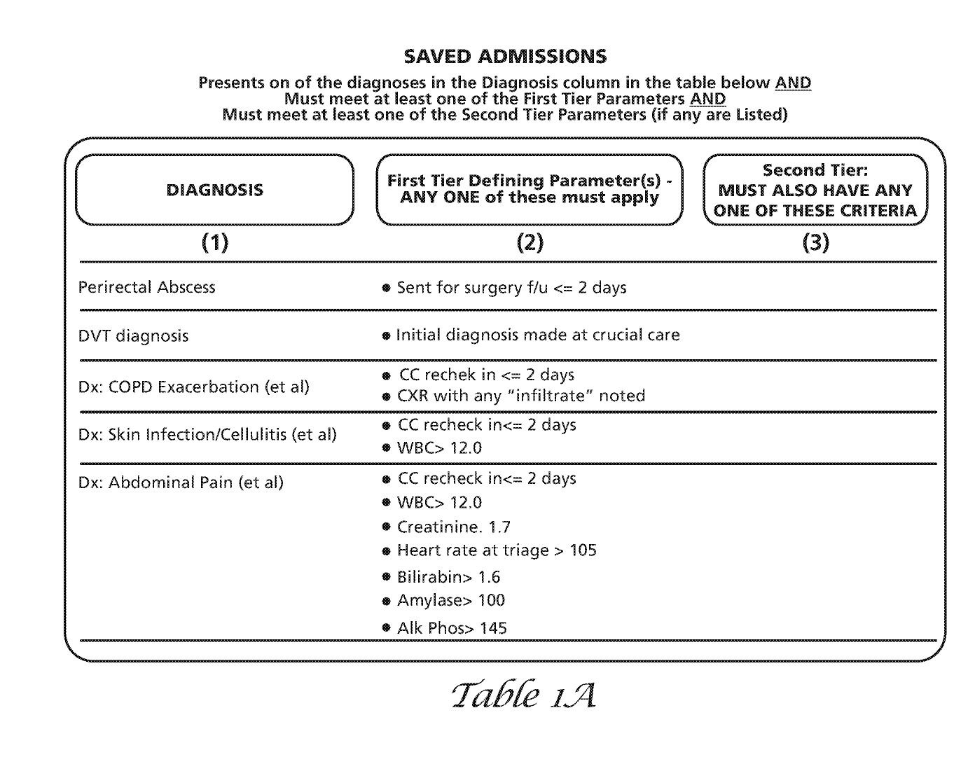

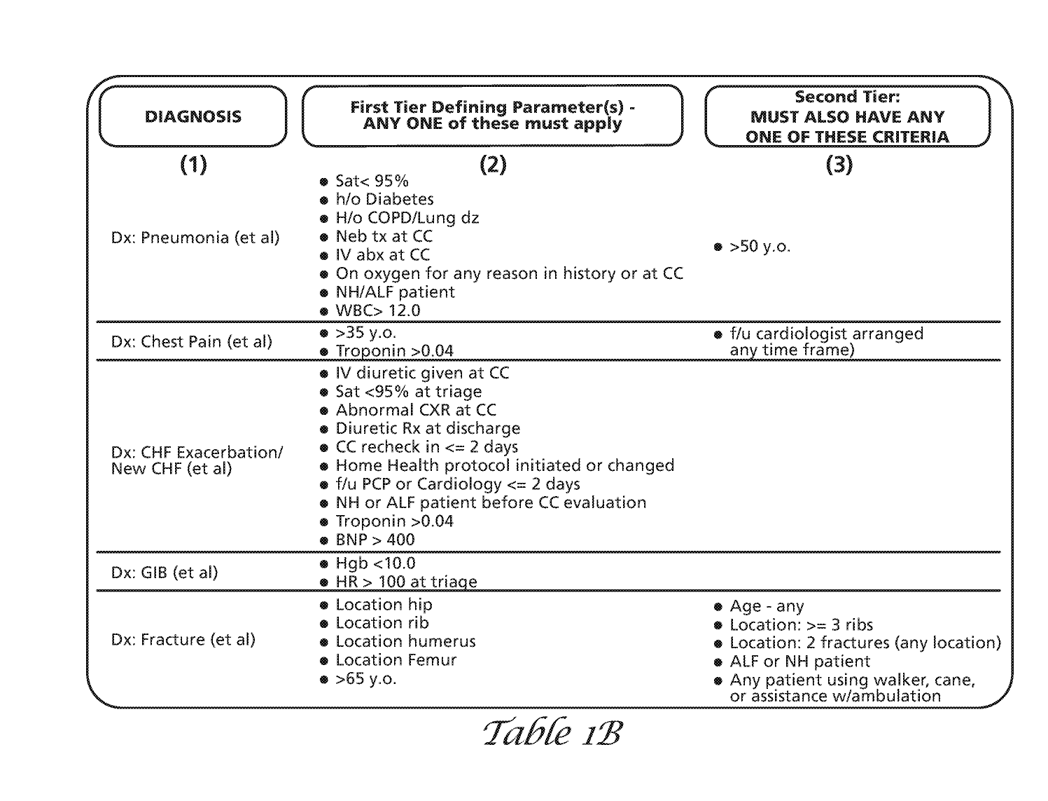

Referring to FIG. 1, FIG. 3 and FIG. 4, following the Saved Admit Review (Step S600), the patient-cases are placed into three categories. First there are those patient-cases that are referred to the hospital for care (Step S700). These are identified as Hospital Admissions in the method as shown in FIG. 4. Second, as illustrated in FIG. 1 and FIG. 3, there are those patient-cases that are properly managed at the acute care facility and these are identified as Saved Admissions (Step S800). Finally, as shown in FIG. 1, if high acuity patient-cases are not Saved or Hospital Admissions, they are considered in the method for further analysis through the Saved Obs Review (Step S900).

Referring to FIG. 1 and FIG. 4, the Saved Obs Review segregates patient-cases remaining in the data set after the Saved Admission Review into two categories. First, patient-cases that meet one of the following criteria identified in Table 3 are considered to be Saved Obs cases. These include all Evaluation and Management (E&M) level 5 cases or all E&M level 3 or 4 cases with any abnormal lab values, and all E&M level 3 or 4 cases where the patient is above a certain age and the patient-case clinical information indicates that troponin tests have been ordered. Referring to FIGS. 1 and FIG. 4, if any one of the above criteria are present, the patient-case is categorized as a Saved Obs (Step S1000). If none of the criteria are met, the patient-case is classified as a High Acuity case that is treated and discharged (Step S1100).

As illustrated in FIG. 1, when the method concludes, patient-cases are stratified in four categories (Steps S700, S800, S1000, and S1100). Within each category, the total number of patient-cases can be tabulated and other assessments can be made (Step S1200).

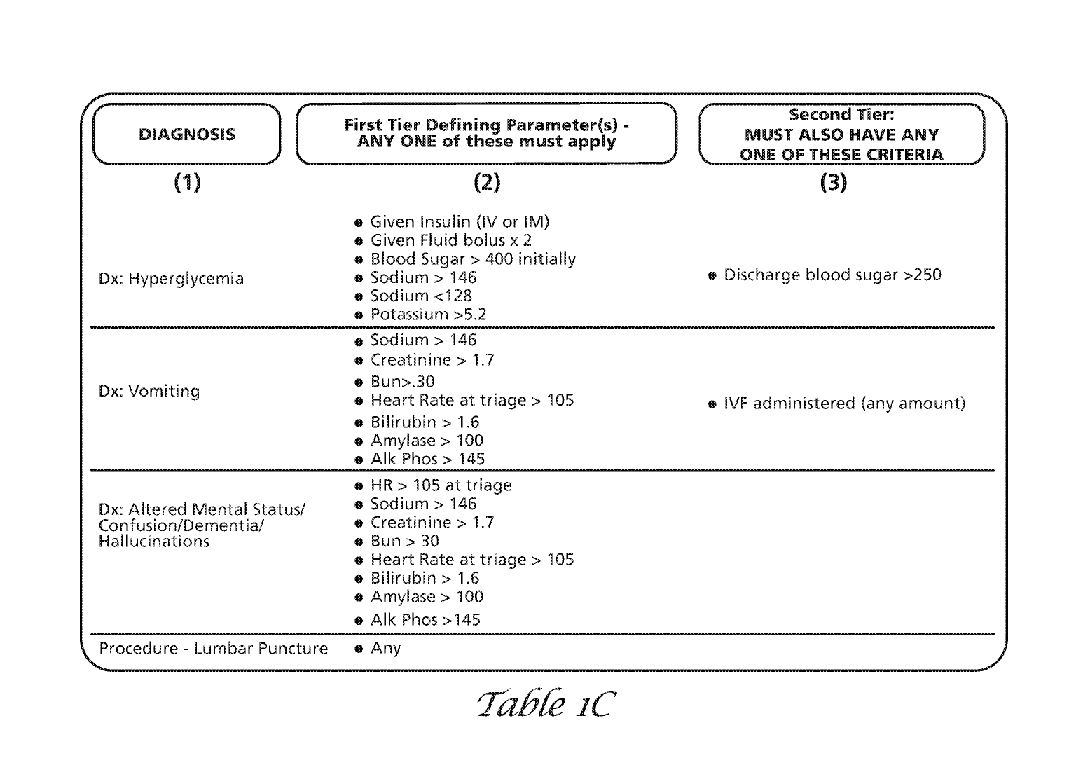

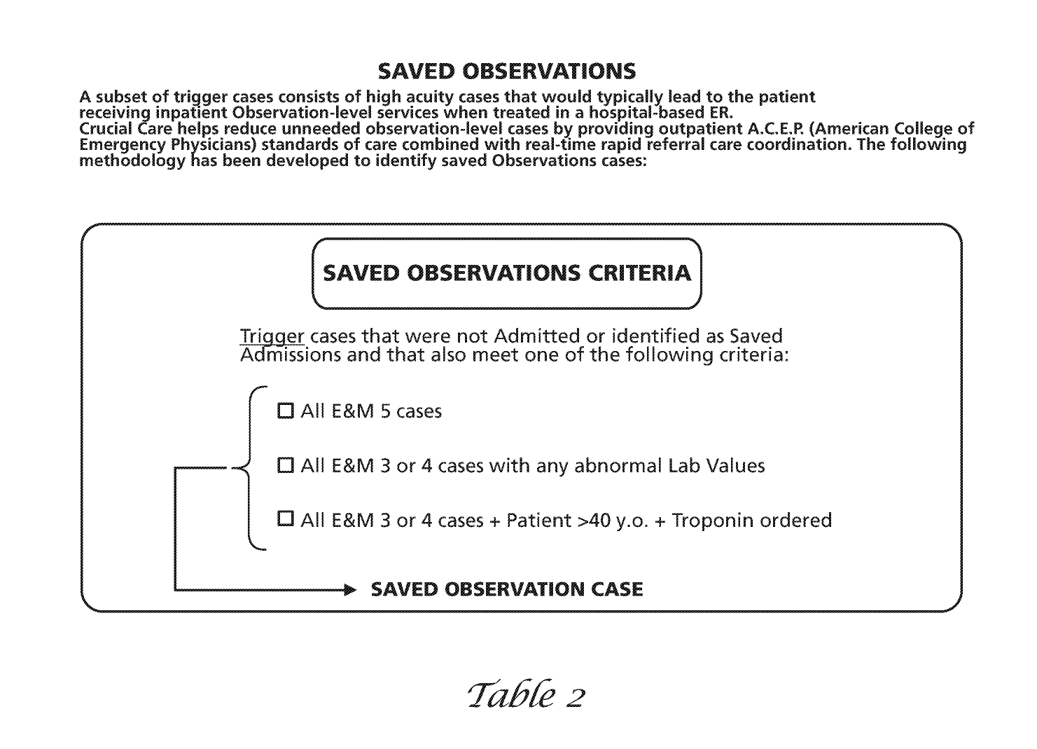

Referring to FIG. 5, the method results can be combined with market savings data to estimate the cost savings created through the ER diversion program. The percentage of patient-cases in each category can also be calculated. A successful ER diversion program will show increasing numbers and percentages for Saved Admissions, and Saved Obs patient-cases over time. Consequently, total savings will also increase as well and accumulate. FIG. 5 provides an example of a Savings Report which can be generated by an acute urgent care facility to illustrate method results and the related cost savings. The Cost Savings Report illustrated in FIG. 5, is merely exemplary and not representative of an exclusive use of the method results assessment.

To further illustrate the method, referring to FIG. 1, consider a hypothetical data set of ten patient-cases that are managed at an acute urgent care center that has recently been located in the vicinity of an ER and associated hospital where ER diversion strategies are needed. Each patient entering the acute urgent care center is seen by a practicing professional and all patient information is charted as generated (Step S100). The patient data which includes the resolution of the case is uploaded and maintained on a central server (Step S200). After a period of time, a medical care analyst or administrator will upload the patient data and perform the acuity analysis (Step S300).

Of the ten patient-cases in this hypothetical scenario, three are diagnosed with common ailments (e.g., head cold, minor bruises, etc.) and the CPT codes assigned to these three cases consequently do not appear in Table 1 as trigger coded and the case is not identified as a trigger case. Again referring to FIG. 1, these patient-cases are treated and discharged from the acute urgent care center (Step S500). The remaining seven patient-cases are then determined to be high acuity cases (Step S400) for analysis based on the trigger-case algorithm presented in FIG. 2. For these seven patient-cases, the CPT code diagnoses do appear in Table 1, and these patients can be considered to be diverted from the nearby ER. Although not fully described in this specification, this diversion can be further validated through a complimentary analysis of patient-case data generated within the ER before and after the acute urgent care center opening date.

Continuing to refer to FIG. 1, the seven high acuity cases are further evaluated in the method through the Saved Admit Review (Step S600) and Saved Obs Review (Step S900) steps. Within the Saved Admit Review (Step S600) two high acuity cases are noted as having been fully evaluated and referred for hospital treatment based on the severity of the patient-case (Step S700). These two cases are noted as being referred to the hospital within the case resolution. Three of the remaining five patient-cases are found to have diagnosis, clinical, biographical or other parameters that match those presented in Table 2, columns 1 through 3 when applicable (Step S800). These three patient-cases are considered to be Saved Admissions (Step S800).

Continuing to refer to FIG. 1, the remaining two patient-cases are carried to the next step of analysis to determine if they are Saved Observations (Step S900). One of the remaining patient-cases reviewed was greater than 40 years old, troponin testing was ordered and was diagnosed as an E&M level 3 case. According to Table 3 criteria, with these characteristics, this patient-case would qualify as a Saved Observation (Step S1000). The other patient-case considered does not meet any of the criteria within Table 3 and is ultimately discharged from the center. This last patient is classified as a High Acuity Case Treated and Discharged (Step S1100).

Following the method implementation, the ten patient-cases are stratified as follows. First, there are three patient cases that have non-high-acuity conditions that are treated and discharged (Step S500). Second, there are seven high acuity patients (Step S400). Of these high acuity patient-cases, two are referred for hospital care (Step S700) and three are saved from admission to the hospital (Step S800). One high acuity patient-case is classified as a saved observation (Step S1000), and finally, one case is simply treated and discharged (Step S1100).

Once the patient-cases are stratified through the method, the medical care analyst or administrator can assess the results (Step S1200). This analysis can be dovetailed with a mirror analysis at the benefited ER to see if admissions or observations are correspondingly reduced by the presence of the acute urgent care center. Referring to FIG. 5, one assessment method can also tabulate the expected savings due to known cost differentials between outpatient and inpatient services. As shown in FIG. 5, reports of patient stratification (based on percentages) and cost savings can also be generated.

What is claimed is:

1. A patient-sorting method for stratifying patient-cases, comprising the steps of:
maintaining a database of patient-cases over a selected time period;
ranking patient-cases based on an acuity analysis;
creating a secondary database of high acuity patient-cases;
determining which high acuity patient-cases qualify as saved admissions;
creating a tertiary database of high acuity patient-cases; and
determining which high acuity patient-cases qualify as saved observations.

2. The patient-sorting method of claim 1, wherein the record of patient-cases is maintained electronically.

3. The patient-sorting method of claim 1, wherein the steps are sequential.

4. The patient-sorting method of claim 1, wherein the ranking patient cases based on an acuity analysis comprises:
comparing the database of patient-cases to a number of pre-selected current procedural terminology (“CPT”) codes;
compiling patient-cases from the database whose diagnoses matches at least one of the pre-selected CPT codes to create the secondary database; and
reporting patient-cases from the database whose diagnoses do not match any of the preselected CPT codes.

5. The patient-sorting method of claim 4, wherein determining which acute patient-cases qualify as saved admissions comprises:
comparing the secondary database of acute patient-cases to saved admission criteria consisting of diagnoses, first tier criteria and second tier criteria;
compiling patient-cases from the secondary database whose diagnoses, clinical and biographical information match the saved admission criteria;
compiling patient-cases from the secondary database that are referred to the hospital;
reporting acute patient-cases from the secondary database that are hospital referrals;
reporting patient-cases from the secondary database whose diagnoses, clinical and biographical information match the saved admission criteria as saved admissions; and
removing high acuity patient-cases that are referred to the hospital and saved admissions from the secondary database to form the tertiary database.

6. The patient-sorting method of claim 5, wherein determining which high acuity patient-cases qualify as saved observations comprises:
comparing the high acuity patient-cases in the tertiary database to saved observation criteria consisting of:
evaluation and management codes,
evaluation and management codes and laboratory results, or
evaluation and management codes, patient age, and required testing;
compiling high acuity patient-cases from the tertiary database whose patient information matches at least one of the saved observation criteria;
compiling high acuity patient-cases from the tertiary database whose patient information does not match at least one the saved observation criteria;
reporting high acuity patient-cases as saved observations when patient-case information matches at least one of the saved observation criteria and
reporting high acuity patient-cases as high acuity treated and discharged patient-cases when patient-case information does not match at least one of the saved observation criteria.

7. The patient-sorting method of claim 1, providing a user-interface adapted to allow for data entry and report requests.

8. The patient-sorting method of claim 7, wherein the user-interface is web-based.

9. The patient-sorting method of claim 8, further comprising a screen presenting a plurality of report formats in one or more boxes.

10. A patient-sorting system, comprising:
means for inputting patient-cases to a database;
means for stratifying patient-cases based on CPT Codes, diagnoses, patient-case biographical information, and clinical information;
means for classifying patient-cases based on acuity;
means for determining if a patient-case is a saved admission;
means for determining if a patient-case is a saved observation;
means for grouping patient-cases for assessment; and
means for generating reports.

11. The patient-sorting system of claim 10, wherein the database of patient-cases is maintained on a central server.

12. The patient-sorting system of claim 11, wherein the central server can be accessed from remote locations for inputting patient-cases to the database.

13. The patient sorting system of claim 10, where the means for classifying patient cases based on acuity:
compares the database of patient-cases to a number of pre-selected current procedural terminology (“CPT”) codes;
compiles patient-cases from the database whose diagnoses matches at least one of the pre-selected CPT codes to create a secondary database; and
reports patient-cases from the database whose diagnoses do not match any of the preselected CPT codes.

14. The patient sorting system of claim 13, where the means for determining if a patient-case is a saved admission:
compares the secondary database of high acuity patient-cases to saved admission criteria consisting of diagnoses, first tier criteria and second tier criteria;
compiles high acuity patient-cases from the secondary database whose diagnoses, clinical and biographical information match the saved admission criteria;
compiles high acuity patient-cases from the secondary database that are referred to the hospital;
reports high acuity patient-cases from the secondary database that are hospital referrals;
reports high acuity patient-cases from the secondary database whose diagnoses, clinical and biographical information match the saved admission critiera as saved admissions; and
removes high acuity patient-cases that are referred to the hospital and saved admissions from the secondary database to form a tertiary database.

15. The patient sorting system of claim 14, where the means for determining if a patient-case is a saved observation:
compares the high acuity patient-cases in the tertiary database to saved observation criteria consisting of:
evaluation and management codes,
evaluation and management codes and laboratory results, or
evaluation and management codes, patient age, and required testing;
compiles high acuity patient-cases from the tertiary database whose patient information matches at least one of the saved observation criteria;
compiles high acuity patient-cases from the tertiary database whose patient information does not match at least one the saved observation criteria;
reports high acuity patient-cases as saved observations when patient-case information matches at least one of the saved observation criteria and reports high acuity patient-cases as high acuity treated and discharged patient-cases when patient case information does not match at least one of the saved observation criteria.

16. A patient-sorting system, comprising:
at least one terminal with a computer configured to:
receive patient-case data;
assign patient-case numbers; and
maintain a database of patient-cases; and
a central server configured to:
store patient-case data;
compare the database of patient-cases to a number of pre-selected current procedural terminology (“CPT”) codes;
compile patient-case data from the database whose diagnoses matches at least one of the pre-selected CPT codes to create a secondary database;
report patient-cases from the database whose diagnoses do not match any of the preselected CPT codes;
compare the secondary database of high acuity patient-cases to saved admission criteria consisting of diagnoses, first tier criteria and second tier criteria;
compile high acuity patient-cases from the secondary database whose diagnoses, clinical and biographical information match the saved admission criteria;
compile high acuity patient-cases from the secondary database that are referred to the hospital;
report high acuity patient-cases from the secondary database that are referred to the hospital;
report high acuity patient-cases from the secondary database whose diagnoses, clinical and biographical information match the saved admission criteria as saved admissions;
remove high acuity patient-cases that are referred to the hospital and saved admissions from the secondary database to form a tertiary database;
compare the high acuity patient-cases in the tertiary database to saved observation criteria consisting of:
evaluation and management codes,
evaluation and management codes and laboratory results, or
evaluation and management codes, patient age, and required testing;
compile high acuity patient-cases from the tertiary database whose patient information matches at least one of the saved observation criteria;
compile high acuity patient-cases from the tertiary database whose patient information does not match at least one the saved observation criteria;
report high acuity patient-cases as saved observations when patient-case information matches at least one of the saved observation criteria;
report high acuity patient-cases as high acuity treated and discharged patient-cases when patient-case information does not match at least one of the saved observation criteria; and
generate reports.

17. The patient-sorting system of claim 16, wherein the patient-case data can be received by the central server from multiple terminal locations.

18. The patient-sorting system of claim 16, wherein the reports can illustrate predictions of cost savings based on patient-case groupings.
